(19) United States
(12) Patent Application Publication
(10) Pub. No.: US 2026/0055854 A1
(43) Pub. Date: Feb. 26, 2026

(54) TEMPORARY PRODUCT CAPTURE CONTAINMENT BUFFER SYSTEM TO ASSIST WITH HYDROCARBON RECOMPRESSION OPERATIONS IN OIL AND GAS OPERATIONS

(71) Applicant: ZENRG Services, LLC, Houston, TX (US)

(72) Inventors: Sam EDWARDS, Sugar Land, TX (US); Joe CHANDLER, Houston, TX (US); Cameron BRASIER, Spring, TX (US); Ronald WILLIAMS, Kingwood, TX (US)

(21) Appl. No.: 19/310,144

(22) Filed: Aug. 26, 2025

Related U.S. Application Data
(60) Provisional application No. 63/687,015, filed on Aug. 26, 2024.

(51) Int. Cl. F17D 3/10; F17D 5/00

(52) U.S. Cl. CPC F17D 3/10; F17D 5/005

(57) ABSTRACT

Systems and methods for temporary product capture, containment, and buffering to assist with hydrocarbon recompression and recapture operations in oil and gas environments is provided. In some aspects, the systems and methods are adapted to control a flow of fluid from an upstream location of a flowline of an oil and gas well into an inflatable, via a first conduit, until either a head pressure of the fluid within the flowline reaches a predetermined head pressure or a volume of fluid within the inflatable reaches a predetermined inflatable volume limit.

### CROSS-REFERENCE TO RELATED APPLICATIONS

This application claims priority under 35 U.S.C. § 119(e) to U.S. Provisional Application No. 63/687,015, filed Aug. 26, 2024, and entitled “TEMPORARY PRODUCT CAPTURE CONTAINMENT BUFFER SYSTEM TO ASSIST WITH HYDROCARBON RECOMPRESSION OPERATIONS IN OIL AND GAS OPERATIONS” the contents of which are hereby incorporated by reference in their entirety.

### FIELD

The subject matter described herein relates to systems and methods for upstream unloading of fluid pressure from production oil and gas wells and for methane gas capture during frac plug drill-out operations.

### BACKGROUND

Production oil and gas wells can accumulate liquids within the tubing strings of the well to the point where gas pressure from a formation can no longer overcome a static head pressure of the liquids. This liquid accumulation can prevent the well from producing flow. Conventionally, wells that experience this sort of liquid accumulation are brought back online by venting top side gas pressure from the well head (e.g., the flow line gas that all adjacent wells feed into) to the atmosphere. The process of venting the hydrocarbon gases to the atmosphere has severe adverse financial and environmental implications. Venting to atmosphere wastes valuable gases, and the pollution that results from the venting processes of conventional liquid unloading methods is undesirable due to regulation restrictions that are put on greenhouse gas emissions.

Alternatively, during the frac plug drill-out process, which is performed during oil and gas well completions, free methane gas is often produced, which is conventionally vented to atmosphere. This is particularly true for wells that contain frac plugs that are drilled out using coiled tubing or specialized drilling or completion rigs designed for those conditions (e.g., horizontal unconventional wells). Horizontal unconventional wells often use multi-stage hydraulic fracturing, where frac plugs are spaced at intervals throughout the target producing intervals to isolate segments of the reservoir to be fracked as part of the completion process. The number of frac plugs can vary great and are often dependent on the wells lateral length and producing interval but can be up to as many as 200 per well. After each zone is fracked, and the wellbore is connected to the reservoir, a plug is set in order to frac the next higher interval. Each time this is done, hydrocarbons can accumulate in the wellbore and be “trapped” after the plug. These plugs must be removed (e.g., drilled out, dissolved, etc.) to allow the well to begin producing. As each plug is removed, the well is often completed with a fluid system that creates an underbalance scenario that results in gas flowing back to the surface at highly erratic pressures. Accordingly, this highly erratic flow of gas is traditionally vented to atmosphere or flared, wasting the valuable gases, causing the same detrimental environmental and financial effects described above.

### SUMMARY

In one aspect, a method for temporary product capture, containment, and buffering to assist with hydrocarbon recompression and recapture operations in oil and gas environments is provided. The method includes controlling a flow of fluid from an upstream location of a flowline of an oil and gas well into an inflatable, via a first conduit, until either a head pressure of the fluid within the flowline reaches a predetermined head pressure or a volume of fluid within the inflatable reaches a predetermined inflatable volume limit.

In some aspects, the method may further include closing a valve provided along the first conduit to stop the flow of fluid into the inflatable responsive to the volume of fluid within the inflatable reaching the predetermined inflatable volume limit; and operating a pump or compressor that may be operatively coupled to the inflatable, via the first conduit, to pull fluid from the inflatable and direct the fluid to a downstream location of the flowline, via a second conduit.

In some aspects, the method may further include diverting the flow of fluid from the upstream location of the flowline to the downstream location of the flowline, via a bypass conduit, responsive to the head pressure of the fluid within the flowline to reach a predetermined head pressure.

In some aspects, the pump or compressor may be operated to pull fluid from the inflatable and direct the fluid to the downstream location of the flowline, responsive to the flow of fluid being diverted from the upstream location of the flowline to the downstream location of the flowline, via the bypass conduit.

In some aspects, the method may further include repeating the steps of controlling the flow of fluid from the upstream location of the flowline into the inflatable, via the first conduit, and operating the pump or compressor to pull fluid from the inflatable and direct the fluid to the downstream location of the flowline, via the second conduit, until the head pressure of the fluid within the flowline reaches the predetermined pressure.

In some aspects, the method may further include simultaneously controlling the flow of fluid from the upstream location of the flowline into the inflatable, via the first conduit, and controlling the pump or compressor to pull fluid from the upstream location of the flowline, via the first conduit, and directing the fluid to the downstream location of the flowline, via the second conduit.

In another aspect, a system for temporary product capture, containment, and buffering to assist with hydrocarbon recompression and recapture operations in oil and gas environments is provided. The system includes an inflatable; a pump or compressor; a first conduit operatively coupling the inflatable and an inlet of the pump or compressor to an upstream location of a flowline of an oil and gas well, wherein the first conduit may be adapted to control a flow of fluid from the upstream location into the inflatable until a head pressure of the fluid within the flowline reaches a predetermined head pressure or a volume of fluid within the inflatable reaches a predetermined inflatable volume limit; and a second conduit operatively coupling an outlet of the pump or compressor to a downstream location of the flowline, wherein the pump or compressor may be adapted to pull fluid from the inflatable and direct the fluid to a downstream location of the flowline, via the second conduit.

In some aspects, the system may further include a bypass conduit operatively coupling the upstream location of the flowline to the downstream location of the flowline, wherein the bypass conduit may include a bypass valve that may be adapted to be in a closed position when fluid is flowing from the upstream location into the inflatable.

In some aspects, the system may further include a first valve provided along the first conduit, wherein the first valve may be adapted to close to stop the flow of fluid into the inflatable responsive to the volume of fluid within the inflatable reaching the predetermined inflatable volume limit.

In some aspects, the bypass valve may be adapted to move to an open position to divert the flow of fluid from the upstream location of the flowline to the downstream location of the flowline, via the bypass conduit, responsive to the head pressure of the fluid within the flowline to reaching the predetermined head pressure.

In some aspects, the pump or compressor may be operated to pull fluid from the inflatable and direct the fluid to the downstream location of the flowline, responsive to the flow of fluid being diverted from the upstream location of the flowline to the downstream location of the flowline, via the bypass conduit.

In some aspects, the system may further include a modulating pressure regulator valve provided upstream of the inflatable that may be arranged to limit the flow of fluid from the upstream location into the inflatable at or below a predetermined pressure limit.

In some aspects, the inflatable may further include a pressure safety valve that may be arranged to automatically open to release pressure within the inflatable when a pressure within the inflatable exceeds a preset level.

In one aspect, another system for temporary product capture, containment, and buffering to assist with hydrocarbon recompression and recapture operations in oil and gas environments is provided. The system includes an inflatable; a conduit system defining a first flow path from an upstream location of a flowline of an oil and gas well into the inflatable, and a second flow path from the inflatable, through a pump or compressor, to a downstream location of the flowline, wherein the conduit system may be arranged to control a flow of fluid from the upstream location into the inflatable, along the first flow path, and pull fluid from the inflatable, via the pump or compressor, to direct the fluid to the downstream location of the flowline, along the second flow path.

In some aspects, the conduit system may further include a bypass flow path from the upstream location of the flowline to the downstream location of the flowline, the system may further include a first valve provided along the first flow path; and a bypass valve provided along the bypass flow path.

In some aspects, the first valve may be adapted to be in an open position and the bypass valve may be adapted to be in a closed position when fluid is flowing from the upstream location into the inflatable.

In some aspects, the first valve may be adapted to close to stop the flow of fluid into the inflatable responsive to the volume of fluid within the inflatable reaching the predetermined inflatable volume limit, and the bypass valve may be adapted to move to an open position to divert the flow of fluid from the upstream location of the flowline to the downstream location of the flowline, along the bypass flow path, responsive to the head pressure of the fluid within the flowline to reaching the predetermined head pressure.

In some aspects, the system may further include the pump or compressor, wherein the pump or compressor may be operated to pull fluid from the inflatable and direct the fluid to the downstream location of the flowline, along the second flow path, responsive to the flow of fluid being diverted from the upstream location of the flowline to the downstream location of the flowline along the bypass flow path.

In some aspects, the system may further include a modulating pressure regulator valve provided upstream of the inflatable that may be arranged to limit the flow of fluid from the upstream location into the inflatable at or below a predetermined pressure limit.

In some aspects, the system may further include a control system that may be arranged to control operations of the pump or compressor and the conduit system.

### BRIEF DESCRIPTION OF THE DRAWINGS

These and other features will be more readily understood from the following detailed description taken in conjunction with the accompanying drawings, in which:

FIG. 1 is a system diagram illustrating an exemplary system for recapturing fluids from liquid-loaded wells;

FIGS. 2A-2D depict a series of diagrams illustrating an exemplary operation of using the system of FIG. 1 to unload a liquid-loaded well and capture and contain the unloaded liquid;

FIGS. 3A-3B depict a series of diagrams illustrating another exemplary operation of using the system of FIG. 1 to unload a liquid-loaded well and capture and contain the unloaded liquid;

FIG. 4 is a diagram illustrating another exemplary operation of using the system of FIG. 1 to unload a liquid-loaded well and capture and contain the unloaded liquid; and

FIG. 5 is a diagram illustrating a frac plug drill-out operation, which can be performed using the inflatable gas capture systems described herein.

It is noted that the drawings are not necessarily to scale. The drawings are intended to depict only typical aspects of the subject matter disclosed herein and therefore should not be considered as limiting the scope of the disclosure.

### DETAILED DESCRIPTION

Liquid loading in gas wells is caused when the gas velocity in the production tubing drops below the critical velocity required to continuously lift reservoir liquids to the surface. Common unloading strategies include opening the well to atmosphere to create a “surge” delta pressure event causing the flow to reinitiate. However, the process of venting the hydrocarbon gases to the atmosphere has severe adverse financial and environmental implications.

Additionally, during oil and gas well completions on wells that contain frac plugs, the frac plugs need to be removed after each zone is fracked. Conventionally, frac plug drill-out operations include successively drilling out the frac plugs resulting in gas flowing back to the surface at highly erratic pressures. Thus, typically, the gas is not captured at this stage but is rather vented to the atmosphere or flared or combusted. The resulting impact of this process is that the revenue associated with this hydrocarbon product is lost, CO2 and some residual methane is released into the atmosphere, and a flame is present resulting in risk and public scrutiny.

The systems and methods described herein address the problems described above by providing a way to remove and recover fluids from a liquid loaded well and/or gases/fluids that arise during frac plug drill-out operations. The systems described herein include a pump and/or compressor and an inflatable (e.g., an industrial balloon type device) that configured to receive the fluids from the well, thereby inflating, quickly depressurizing the well, and allowing the fluids to buffer within the inflatable rather than being vented to the atmosphere or flared. Once the fluids are fully removed from the well and contained in the inflatable, the pump/compressor can remove the fluids from the inflatable and reinject the fluids back into a downstream section of the well.

The systems and methods described herein are advantageously capable of capturing all fluids that are unloaded from a liquid loaded well or during a frac plug drill-out operation, allowing the well to resume production, and reinjecting the recovered fluids/gases back into the flow line, thereby preventing the venting of any hydrocarbons into the atmosphere, providing significant financial and environmental benefits.

There is a high degree of variance on the types of fluids received while unloading a liquid loaded well and it is highly dependent on the geologic basin where the well is being produced. In some cases, the initial phase of the liquid unloading process will include a gas phase, followed by a liquids phase which can include condensate, oil, water, and potentially solids which are captured in the separator.

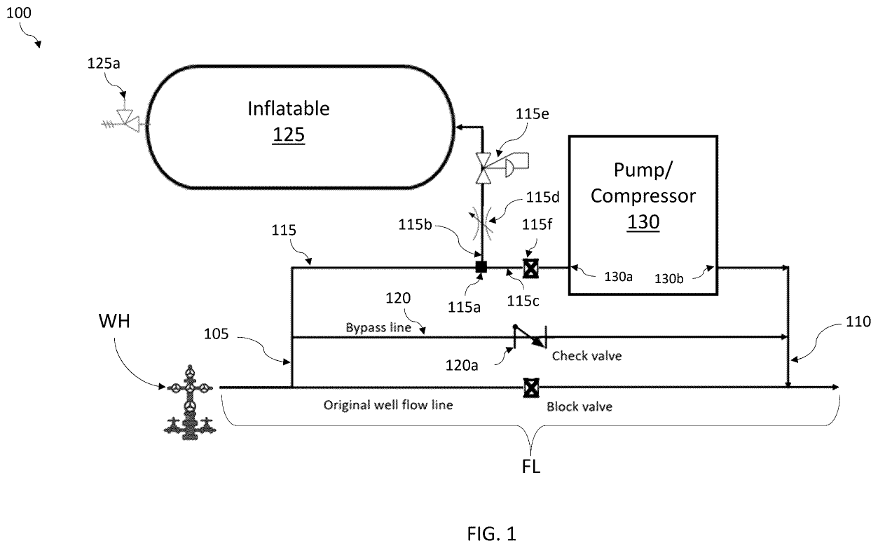

FIG. 1 is a system diagram illustrating an exemplary system 100 that can be used for unloading liquid-loaded wells while also capturing and containing the unloaded liquid, recompressing the liquid, and reinjecting the unloaded liquid into a downstream section of the well. Accordingly, the system 100 substantially reduces pollutant emissions and substantially increases product recovery in oil and gas operations.

In some aspects, prior to performing a liquid-unloading process, the system 100 can be tied into an existing well flow line FL extending from a well head WH of an oil and gas well. For example, as shown in FIG. 1, the well flow line FL can include a block valve that can open and close the flow line FL, and the system 100 can include a first conduit 105 configured to tap the flow line FL upstream of the block valve, and a second conduit 110 configured to tap the flow line FL downstream of the block valve. In some aspects, an unloading line/conduit 115 and a bypass line/conduit 120 can be provided between the first conduit 105 and the second conduit 110, as shown. Further, in some aspects, the unloading line 115 can include a tee 115a adapted to branch the unloading line 115 into a first branch 115b and a second branch 115c, as shown in FIG. 1. The first branch 115b can be provided with a butterfly valve 115d and a pressure regulator valve 115e, also referred to herein as a throttle valve. The system 100 can also include an inflatable 125 which includes an inlet that is coupled to the first branch 115b of the unloading line 115. In some aspects, the inflatable 125 can be made from a material that is suitable for withstanding hydrocarbons and high pressure (e.g., elastomers or composites or the like). In some aspects, the inflatable 125 can also include a plurality of layers and, among which can include a reinforcing layer made from a metallic mesh or the like.

In some aspects, the pressure regulator valve 115e is configured to maintain a desirable pressure of the flow of fluid into the inflatable 125, regardless of variations in the pressure or flow rate into the pressure regulator valve 115e, from the well head WH. For example, if the inflatable 125 is designed to receive a flow of fluid at a certain pressure (e.g., 2 psi), but the flow of fluid from the well head WH within the first branch 115b is 10 psi, the pressure regulator valve 115e can be configured to modulate to limit the flow from 10 psi down to 2 psi before flowing the fluid into the ballon 125. In some aspects, the inflatable 125 can also include a pressure safety relief valve (SRV) 125a configured to protect the inflatable 125 from overpressure conditions by automatically releasing pressure when pressure within the inflatable 125 exceeds a preset level. In some aspects, the SRV 125a can be pre-set to a safe working pressure (e.g., below 15 psig which is non-ASME stamped) and can be adapted to work in conjunction with the throttle valve to stop the flow into the inflatable if the pre-set pressure is exceeded. For example, in some aspects, the valves of the system can be coupled to a controller. In this case, responsive to an internal pressure within the inflatable 125 that exceeds the pre-set safe working pressure, the SRV 125a can be configured to open, which can be communicated to the controller to close the throttle valve to stop the flow into the inflatable 125. In some aspects, a check valve can also be provided to allow gas to leave the inflatable. In summary, the system 100 includes a throttling and choking system to ensure safe operation of the inflatable 125.

The second branch 115c can be provided with a block valve 115f. Additionally, system 100 can include a pump/compressor 130 which includes at least one inlet 130a that is coupled to the second branch 115c of the unloading line 115, downstream of the block valve 115f. An outlet 130b of the pump/compressor 130 can be connected to the second conduit 110 that is configured to tap the flow line FL downstream of the block valve of the flow line FL. In some aspects, the pump/compressor 130 can include more than one pump or compressor, in series or in parallel. In some aspects, the pump/compressor 130 can be operated manually, remotely, or automated. The pump/compressor 130 can function through pneumatic, pressure, electrical mechanical or other hydraulic means. The type of pump or compressor used for the pump/compressor 130 can include, but is not limited to piston, screw, diaphragm, centrifugal, gear, lobe, metering, progressive cavity, plunger or multi-phase types. The pump/compressor 130 can be configured to displace liquids, gases, or mixtures thereof, in a range of 0 to 1,000,000 scf/hour, as standard cubic feet of gas per hour [0-28,316 cubic meters per hour] or 0.1 to 100 Barrels Per Minute of liquid [0.016 to 16 cubic meter per minute]. In some aspects, bypass line 120 can include a check valve 120a, the operation of which is described in greater detail below.

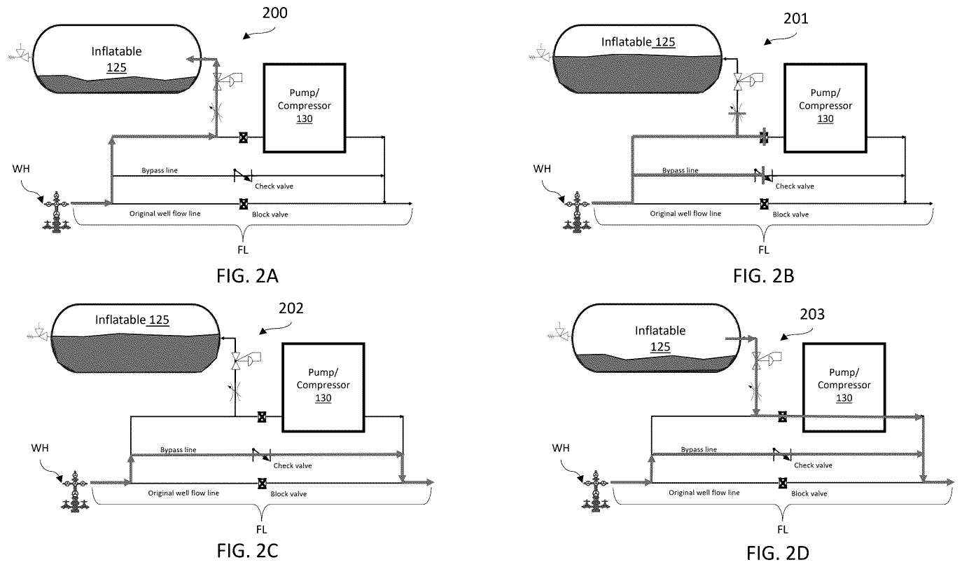

FIGS. 2A-2D depict a series of diagrams 200, 201, 202, 203 of the system 100, illustrating an exemplary operation of using the system 100 to unload a liquid-loaded well and capture and contain the unloaded liquid. Discussion of the exemplary operation of system 100 is provided below with reference made to the description of FIG. 1 above.

In operation, the inflatable 125 can initially be fully deflated. During a liquid-unloading process, the system 100 can be configured to close the block valve of the flowline FL and control a flow of fluids from the well head WH into the inflatable 125, via a flow path defined by the first conduit 105, the unloading line 115 and the first branch 115b, as shown in FIG. 2A. Fluids can be flown from the well head WH into the inflatable 125 until the inflatable 125 reaches a predetermined pressure/volume limit. Once the inflatable 125 reaches the predetermined pressure/volume limit, the system 100 can be configured to close the butterfly valve 115d to stop the flow of fluid into the inflatable 125, to prevent over pressure, and to allow for pressure in the well head WH to build until it reaches a desirable flow line pressure, as shown in FIG. 2B. Once the pressure in the well head WH reaches the desirable flow line pressure, the system 100 can be configured to open the check valve 120a and control the flow of fluids from the well head WH to a downstream production system via the second conduit 110 and the flow line FL, as shown in FIG. 2C.

Once a stable flow of fluid is achieved from the well head WH to the downstream production system via the second conduit 110 and the flow line FL, the system 100 can be configured to open the butterfly valve 115d and the block valve 115f. The system 100 can then operate pump/compressor 130 to pull the fluid contents from the inflatable 125, via a flow path defined by the first branch 115b and the second branch 115c, compress the fluid within the pump/compressor 130 and send the fluids to the downstream production system via the second conduit 110 and the flow line FL, as shown in FIG. 2D.

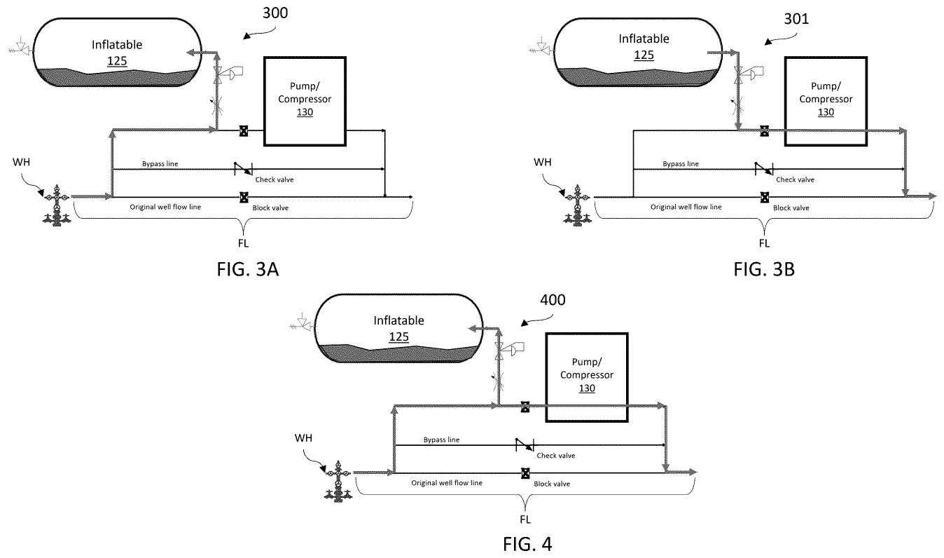

FIGS. 3A-3B depict a series of diagrams 300, 301 of the system 100, illustrating an exemplary operation of using the system 100 in a case where the inflatable 125 reaches the predetermined pressure/volume limit, but the pressure in the well head WH is still not able to build up to a level that is greater than the flow line pressure. In this case, similar to as described above in reference to FIG. 2A, the system can first be arranged to control a flow of fluids from the well head WH into the inflatable 125, via a flow path defined by the first conduit 105, the unloading line 115 and the first branch 115b, as shown in FIG. 3A. If inflatable 125 reaches the predetermined pressure/volume limit and the pressure in the well head WH is still not able to build up to a level that is greater than the flow line pressure, then the system 100 can be configured to empty the inflatable 125 into the downstream production system using the pump/compressor 130, as shown in FIG. 3B. Once the inflatable 125 is emptied, the block valve 115f can be closed and the process shown in FIG. 3A can be repeated. In some aspects, the butterfly valve 115d can also be closed after the process shown in FIG. 3B, to allow for the well head pressure to build up again before repeating the process shown in FIG. 3A. In some aspects, this process can be repeated until the well head pressure exceeds the pressure of the flow line. Once the pressure in the well head WH reaches the desirable flow line pressure, the system 100 can be configured to open the check valve 120a and control the flow of fluids from the well head WH to a downstream production system, as described above in reference to FIGS. 2C-2D.

FIG. 4 is a diagram 400 illustrating an exemplary operation of using the system 100 in a case where it may be desirable to allow for more fluid to flow from the well head WH before the inflatable 125 reaches the predetermined pressure/volume limit. In this case, the system 100 can be configured to fill the inflatable 125, while simultaneously operating the pump/compressor 130, as shown in FIG. 4A. In this case, the system 100 can be configured to open the block valve 115f of the second branch 115c and variously control the flow of fluids from the well head WH into both the inflatable 125, via the first branch 115b, and into the pump/compressor 130, via the second branch 115c.

System 100 may be configured for seamless integration with a variety of types of wellhead equipment, including API-compliant flowlines, valves, and pressure monitoring systems. This versatile compatibility enables operators of established pipelines to deploy the systems and methods described herein without requiring significant modifications to existing infrastructure. As a result, operators can efficiently leverage the systems and methods described herein to capture and reinject unloaded fluids back into the flowline, thereby preventing the venting of hydrocarbons into the atmosphere. This approach provides substantial financial benefits by preserving valuable hydrocarbon product and delivers environmental advantages by reducing emissions and eliminating the need for flaring.

In some aspects, the system 100 can further be provided with cross-tees (not shown) across a main axis hose that serves as a product conduit on the bottom of the inflatable 125 adapted to equally distribute the flow into the inflatable from various points as opposed to from a singled filling point on one side of the inflatable 125, as shown. This adaptation can be desirable in liquid-unloading processes that involve high gas/fluid input velocities into the inflatable, to protect the inflatable. In some aspects, impingement plates can be placed at each of the orifices that can accept flow into the inflatable to help ensure that high velocity liquids flowing into the inflatable is slowed down or diverted to prevent wall damaging. Similarly, this can help to ensure a more equal distribution of flow while filling the inflatable. As an option, there can also be a three-way valve put in place that will tie into an ejector pump or venturi, similar to those used in propane air mixers, orifice into the inflatable that might help to remove liquids from the inflatable. In some cases, the inflatable 125 can be set inside of a retention cage (e.g., a piping cage) to prevent the inflatable 125 from filling irregularly and which can be designed to ensure there are no sharp edges to damage the inflatable. In some aspects, the inflatable can be transportable via a work vehicle or a transport container or some other means of transport. In some aspects, the inflatable 125 can be disposed on a hinged support structure that is adapted to fold out to support a base of the inflatable as it inflates. For example, in some cases, the inflatable 125 can be transported—in its deflated form—to a site where the inflatable will be used (e.g., a wellhead). Once the inflatable is at the site, the hinged support structure can be folded out to support a base of the inflatable as it inflates, allowing for an inflated volume of the inflatable 125 to be significantly increased when compared to a bed of the work vehicle or a footprint of the transport container carrying the inflatable.

In some aspects, the system 100 can include two concentric inflatables (not shown) where the external inflatable is materially larger than the internal inflatable. In this case, the external inflatable could be inflated prior to the start of an operation, allowing for more expansion space of the internal inflatable. The external inflatable can also be provided with sensors mounted internally on a frame thereof, to serve as a protection mechanism to detect any potential leaks in the internal inflatable. The utilization of proximity position switches could be mounted that would be engaged when the inflatable is inflated beyond a certain size. This can help to protect the inflatable from overinflation as it would shut off pressure flow into the inflatable. The mounting cage and external inflatable design can also serve as a wind protector when operating in high wind conditions. An important factor to consider when selecting which type of inflatable 125 to use on wells is related to the ratio of the inflatable to the annulus of the well. The annulus of the well is calculated using the area of the tubing and the area of the casing annulus volume in the event the casing is not isolated from the tubing with an end of tubing packer. In some aspects, the inflatables of the system 100 can be sized to cover this annulus as a standalone inflatable or they can be run in parallel. For example, in some aspects, the inflatable 125 can be sized at 1.2 times a maximum possible size of the tubing annulus, and/or tubing and casing annulus. In some aspects, the volume of the inflatable 125 can be sized such that the following condition is met: V_{inflatable}>Vₐₙₙᵤₗᵤₛ+M*t, where M is the choked volumetric flow rate from reservoir and t is the inflatable inflation time.

Additionally, in some aspects, as indicated above, the system 100 can be used during a frac plug drill out operation. In this case, the volume of the inflatable 125 must be large enough to handle the highest potential volume expected from the pressurized area under each of the frac plugs being drilled out. Drip tubes can also be included to help ensure liquids can be pumped out. In this use-case, output from the inflatable 125 can be connected into a dual input compressor that can either accept flow directly from the well or directly from the inflatable. In some aspects, a pump can also be put in place to pump fluids from a sump of the inflatable which may be located below the main axis hose that serves as a product conduit that captures liquids at the base of the inflatable. This sump may be arranged to collect the liquid phase collected during the unloading process and can be connected to a pump that could remove the fluids from the base of the inflatable 125. In some aspects, such a pump may be controlled by a fluid level sensor mounted along the base of the main axis hose. A booster can also be placed between the outlet of the inflatable and the compressor if required for certain pressure situations.

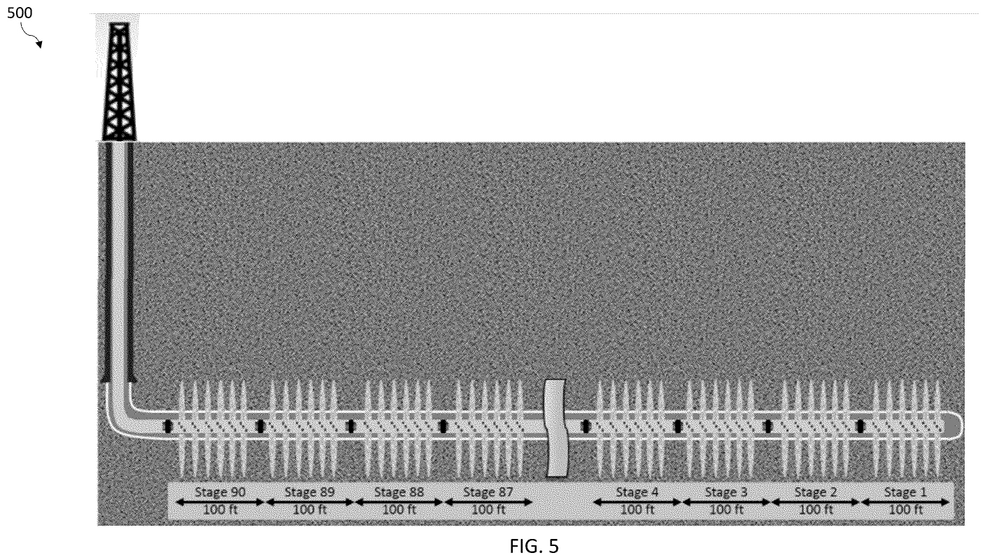

FIG. 5 is a diagram 500 illustrating a 90-stage frac plug drill-out operation. Conventional systems and methods for performing frac plug drill-out operations are unable to capture all of the gas returned to the surface, due to the high degree of variability in flowrate vs. the capacity of compressors available. Accordingly, excess gas returned during this process is traditionally either vented to the atmosphere or flared. The inflatable gas capture systems described herein address this issue by enabling the capture of free gas by buffering the returned volumes of gas that vary greatly based on a number of variables that are controlled by the oil and gas well and frac plug drill out process. As shown in FIG. 5, the 90-stage frac plug drill-out operation involves sequentially drilling out each plug. During these sequential plug drilling operations, gas released between stages is returned to the surface in the well bore completion fluids. Once the fluids, produced gas, and solution gas is returned to the surface, conventional oil and gas technologies exists to separate the liquids from the gases. This separated gas can be captured using an inflatable device (e.g., inflatable 125 of system 100) then recompressed back into another containment vessel of flowline. For example, initially, the plug at stage 90 is drilled out, and the volume of gas between stages 90 and 89 is captured in the inflatable. Subsequently, the plug at stage 89 is drilled out, and the gas volume between stages 89 and 88 is similarly captured. This process can be repeated for each successive stage until all plugs have been drilled out, enabling controlled and staged gas capture throughout the operation. In some aspects, during the frac plug drill out operation, the system 100 can be operated similarly to as described above in reference to FIGS. 3A-3B and 4.

1. A method comprising:
controlling a flow of fluid from an upstream location of a flowline of an oil and gas well into an inflatable, via a first conduit, until a head pressure of the fluid within the flowline reaches a predetermined head pressure or a volume of fluid within the inflatable reaches a predetermined inflatable volume limit.

2. The method of claim 1, further comprising:
closing a valve provided along the first conduit to stop the flow of fluid into the inflatable responsive to the volume of fluid within the inflatable reaching the predetermined inflatable volume limit; and
operating a pump or compressor that is operatively coupled to the inflatable, via the first conduit, to pull fluid from the inflatable and direct the fluid to a downstream location of the flowline, via a second conduit.

3. The method of claim 2, further comprising:
diverting the flow of fluid from the upstream location of the flowline to the downstream location of the flowline, via a bypass conduit, responsive to the head pressure of the fluid within the flowline to reach a predetermined head pressure.

4. The method of claim 3, wherein the pump or compressor is operated to pull fluid from the inflatable and direct the fluid to the downstream location of the flowline, responsive to the flow of fluid being diverted from the upstream location of the flowline to the downstream location of the flowline, via the bypass conduit.

5. The method of claim 2, further comprising:
repeating the steps of controlling the flow of fluid from the upstream location of the flowline into the inflatable, via the first conduit, and operating the pump or compressor to pull fluid from the inflatable and direct the fluid to the downstream location of the flowline, via the second conduit, until the head pressure of the fluid within the flowline reaches the predetermined pressure.

6. The method of claim 2, further comprising:
simultaneously controlling the flow of fluid from the upstream location of the flowline into the inflatable, via the first conduit, and controlling the pump or compressor to pull fluid from the upstream location of the flowline, via the first conduit, and directing the fluid to the downstream location of the flowline, via the second conduit.

7. A system comprising:
a inflatable;
a pump or compressor;
a first conduit operatively coupling the inflatable and an inlet of the pump or compressor to an upstream location of a flowline of an oil and gas well, wherein the first conduit is adapted to control a flow of fluid from the upstream location into the inflatable until a head pressure of the fluid within the flowline reaches a predetermined head pressure or a volume of fluid within the inflatable reaches a predetermined inflatable volume limit;
a second conduit operatively coupling an outlet of the pump or compressor to a downstream location of the flowline, wherein the pump or compressor is adapted to pull fluid from the inflatable and direct the fluid to a downstream location of the flowline, via the second conduit.

8. The system of claim 7, further comprising a bypass conduit operatively coupling the upstream location of the flowline to the downstream location of the flowline, wherein the bypass conduit includes a bypass valve that is adapted to be in a closed position when fluid is flowing from the upstream location into the inflatable.

9. The system of claim 8, further comprising a first valve provided along the first conduit, wherein the first valve is adapted to close to stop the flow of fluid into the inflatable responsive to the volume of fluid within the inflatable reaching the predetermined inflatable volume limit.

10. The system of claim 9, wherein the bypass valve is adapted to move to an open position to divert the flow of fluid from the upstream location of the flowline to the downstream location of the flowline, via the bypass conduit, responsive to the head pressure of the fluid within the flowline to reaching the predetermined head pressure.

11. The system of claim 10, wherein the pump or compressor is operated to pull fluid from the inflatable and direct the fluid to the downstream location of the flowline, responsive to the flow of fluid being diverted from the upstream location of the flowline to the downstream location of the flowline, via the bypass conduit.

12. The system of claim 7, further comprising a modulating pressure regulator valve provided upstream of the inflatable that is configured to limit the flow of fluid from the upstream location into the inflatable at or below a predetermined pressure limit.

13. The system of claim 7, wherein the inflatable further comprises a pressure safety valve configured to automatically open to release pressure within the inflatable when a pressure within the exceeds a preset level.

14. A system comprising:
an inflatable;
a conduit system defining a first flow path from an upstream location of a flowline of an oil and gas well into the inflatable, and a second flow path from the inflatable, through a pump or compressor, to a downstream location of the flowline,
wherein the conduit system is configured to control a flow of fluid from the upstream location into the inflatable, along the first flow path, and pull fluid from the inflatable, via the pump or compressor, to direct the fluid to the downstream location of the flowline, along the second flow path.

15. The system of claim 14, wherein the conduit system further includes a bypass flow path from the upstream location of the flowline to the downstream location of the flowline, the system further comprising:
a first valve provided along the first flow path; and
a bypass valve provided along the bypass flow path.

16. The system of claim 15, wherein the first valve is adapted to be in an open position and the bypass valve is adapted to be in a closed position when fluid is flowing from the upstream location into the inflatable.

17. The system of claim 16, wherein the first valve is adapted to close to stop the flow of fluid into the inflatable responsive to the volume of fluid within the inflatable reaching the predetermined inflatable volume limit, and wherein the bypass valve is adapted to move to an open position to divert the flow of fluid from the upstream location of the flowline to the downstream location of the flowline, along the bypass flow path, responsive to the head pressure of the fluid within the flowline to reaching the predetermined head pressure.

18. The system of claim 17, further comprising the pump or compressor, wherein the pump or compressor is operated to pull fluid from the inflatable and direct the fluid to the downstream location of the flowline, along the second flow path, responsive to the flow of fluid being diverted from the upstream location of the flowline to the downstream location of the flowline along the bypass flow path.

19. The system of claim 15, further comprising a modulating pressure regulator valve provided upstream of the inflatable that is configured to limit the flow of fluid from the upstream location into the inflatable at or below a predetermined pressure limit.

20. The system of claim 19, further comprising a control system configured to control operations of the pump or compressor and the conduit system.
